(19) United States
(12) Patent Application Publication
(10) Pub. No.: US 2026/0003139 A1
(43) Pub. Date: Jan. 1, 2026

(54) OPTICAL DEVICES AND METHODS OF MANUFACTURE

(71) Applicant: Taiwan Semiconductor Manufacturing Co., Ltd., Hsinchu (TW)

(72) Inventors: Ming-Fa Chen, Taichung (TW); Chih-Tsung Tsai, Tainan (CN)

(21) Appl. No.: 18/926,658

(22) Filed: Oct. 25, 2024

Related U.S. Application Data
(60) Provisional application No. 63/665,315, filed on Jun. 28, 2024.

(51) Int. Cl. G02B 6/42

(52) U.S. Cl. CPC G02B 6/4206; G02B 6/4214

(57) ABSTRACT

A semiconductor package including a photonic package coupled to a first side of a package substrate, the photonic package including a semiconductor substrate, an array including multiple rows of coupling lenses on a top surface of the semiconductor substrate, and multiple rows of couplers disposed below the multiple rows of coupling lenses, where each coupler of the multiple rows of couplers is disposed below a corresponding coupling lens of the multiple rows of coupling lenses, first conductive connectors disposed between the photonic package and the first side of the package substrate, where the first conductive connectors are attached to first bond pads on the first side of the package substrate, and where at least one of the first conductive connectors includes a first intermetallic region, and second conductive connectors disposed on a second side of the package substrate that is opposite the first side.

### PRIORITY CLAIM AND CROSS-REFERENCE

This application claims the benefit of U.S. Provisional Application No. 63/665,315, filed on Jun. 28, 2024, entitled “Semiconductor Structure”, which application is hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-10B illustrate the formation of an optical package, in accordance with some embodiments.

FIGS. 10C and 10D illustrate the formation of a package, in accordance with some embodiments.

FIG. 11 illustrates the formation of an optical package, in accordance with other embodiments.

FIG. 12 illustrates the formation of an optical package, in accordance with other embodiments.

FIG. 13 illustrates the formation of an optical package, in accordance with other embodiments.

FIGS. 14A and 14B illustrate the formation of an optical package, in accordance with other embodiments.

FIG. 15 illustrates the formation of an optical package, in accordance with other embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Various embodiments provide methods applied to, but not limited to, the formation of an optical engine that includes an array of silicon (Si) lenses arranged in multiple rows, with corresponding rows of couplers (e.g., grating couplers or edge couplers) positioned beneath these lenses. Advantageous features of one or more embodiments disclosed herein may include the array of silicon (Si) lenses that are arranged in multiple rows allowing for an increase in the optical input/output (I/O) capacity of the optical engine. This increased I/O density allows for a greater number of optical channels to operate simultaneously within the same footprint, thereby expanding the optical communication bandwidth and increasing the data transmission capabilities of the optical engine. In addition, the embodiments provide methods that have a high compatibility with existing manufacturing processes, and that can be easily integrated with the existing manufacturing processes. This may result in reduced manufacturing costs.

The embodiments presented herein are intended to be illustrative and are not intended to limit the embodiments to the precise descriptions as discussed. Rather, the embodiments discussed may be incorporated into a wide variety of implementations, such as silicon photonics in general, or 3-D ICs with photonic applications, and all such implementations are fully intended to be included within the scope of the embodiments.

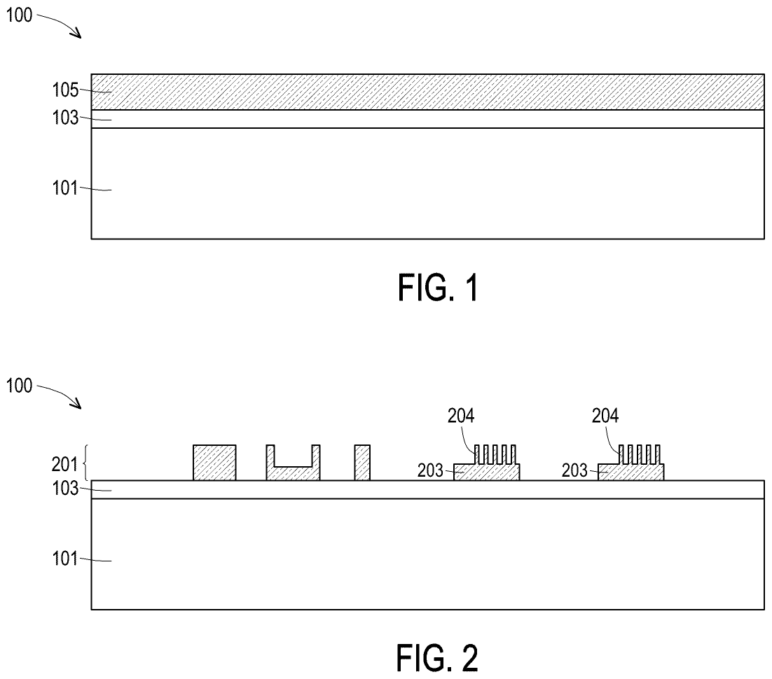

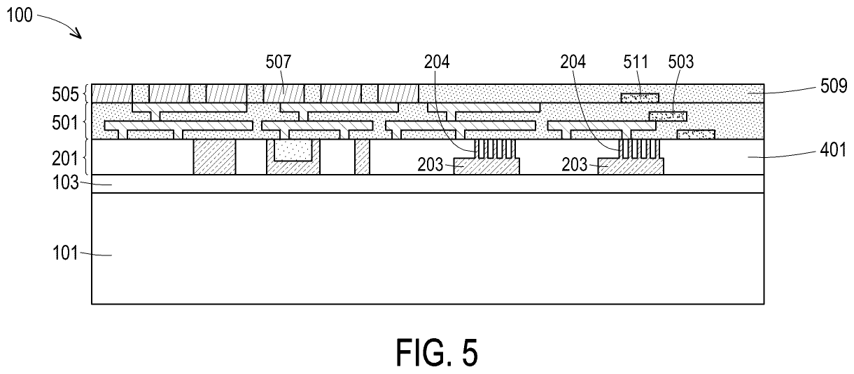

FIGS. 1-10B illustrate formation of a first optical package 40, in accordance with some embodiments With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment, the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments, the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

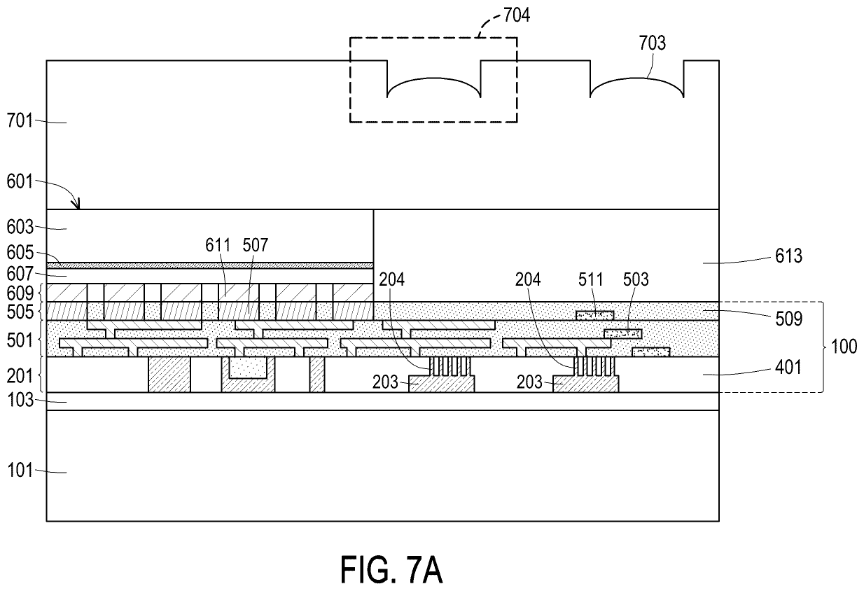

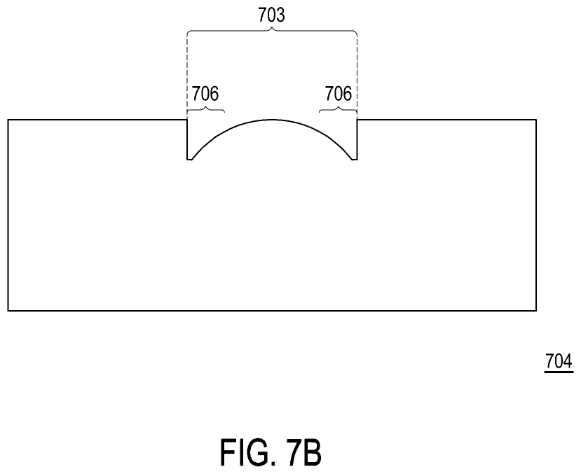

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or couplers, the patterning process may be all or at least most of the manufacturing that is used to form these first optical components 203 components. In some embodiments, the first optical components 203 may include grating couplers 204 that may be formed to be in physical contact with or near surfaces of corresponding waveguides. The grating couplers 204 may be formed as an array of couplers that are arranged in multiple rows, with each row being positioned such that it will be disposed beneath a corresponding row of subsequently formed coupling lenses 703 (shown in FIG. 7A).

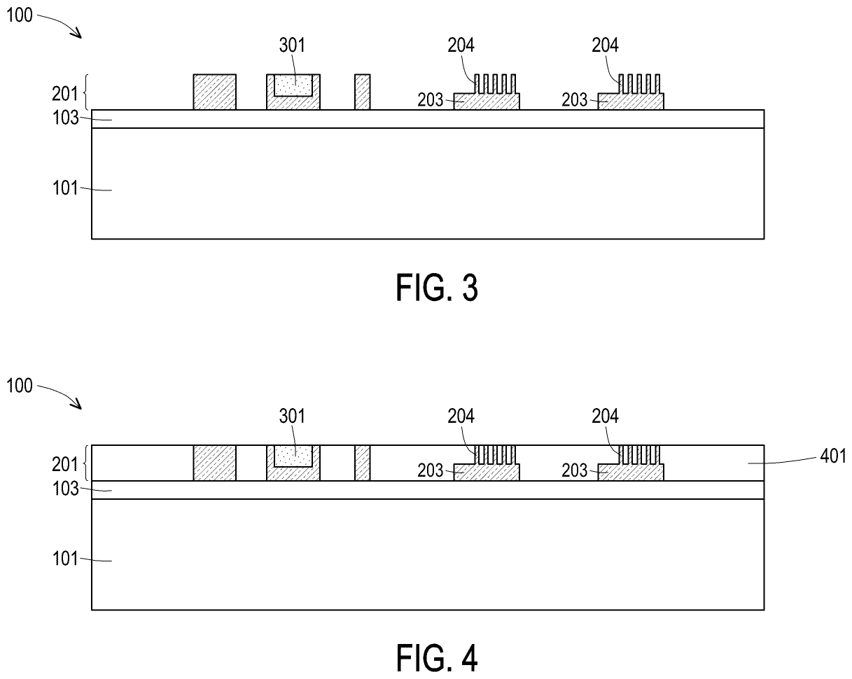

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments, an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

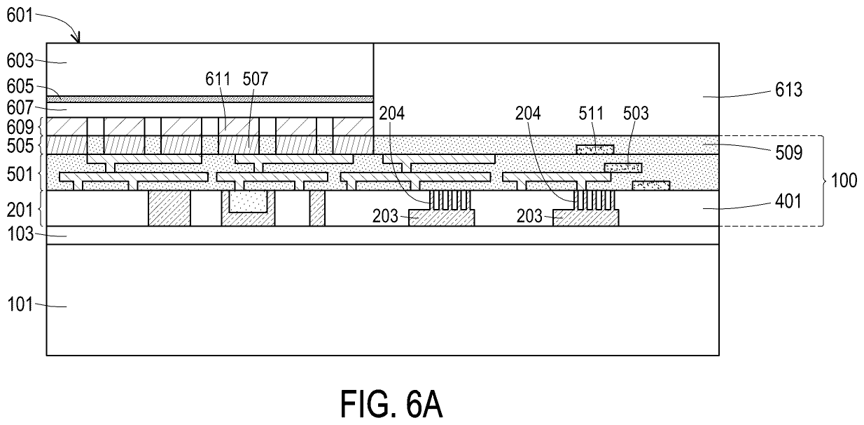

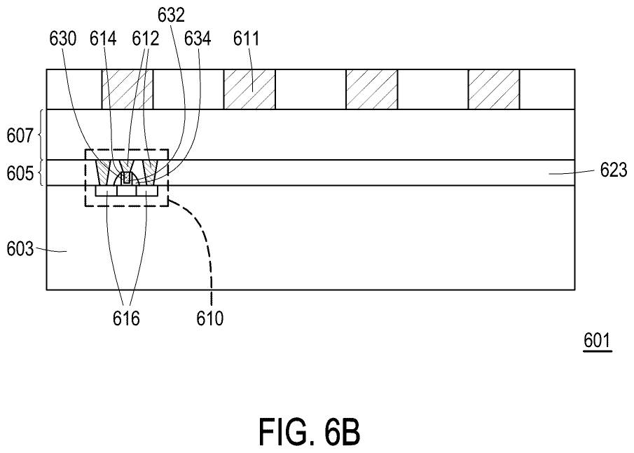

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6A). In an embodiment, the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the first openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the first openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as waveguides and other structures formed at least in part through a deposition and patterning process. However, any suitable structures, materials and any suitable methods of manufacture may be utilized.

FIG. 6A illustrates a bonding of a first semiconductor device 601 to the first bonding layer 505 of the optical interposer 100. FIG. 6B illustrates the first semiconductor device 601. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated second bond pads 611. In an embodiment, the semiconductor substrate 603 may be similar to the first substrate 101 (e.g., a semiconductor material such as silicon or silicon germanium), the active devices 605 may be transistors (e.g., the transistor 610 described in FIG. 6B), capacitors, resistors, and the like formed over the semiconductor substrate 603, the interconnect structure 607 may be similar to the first metallization layers 501 (without optical components), the second bonding layer 609 may be similar to the first bonding layer 505, and the second bond pads 611 may be similar to the first bond pads 507. However, any suitable devices may be utilized. In an embodiment shown in FIG. 6B in which the active devices 605 are transistors (e.g., the transistor 610), an inter-layer dielectric (ILD) 623 is over the front surface of the semiconductor substrate 603. The ILD 623 surrounds and may cover the transistor 610. The ILD 623 may include one or more dielectric layers formed of materials such as Phospho-Silicate Glass (PSG), Boro-Silicate Glass (BSG), Boron-Doped Phospho-Silicate Glass (BPSG), undoped Silicate Glass (USG), a low-k dielectric material or the like.

Conductive plugs 612 extend through the ILD 623 to electrically and physically couple the transistor 610. For example, the conductive plugs 612 may couple a gate structure 614 and source/drain regions 616 of the transistor 610. The gate structure 614 includes at least a gate dielectric layer 630, a gate conductive layer 632 on the gate dielectric layer 630 and a spacer 634 extending along a sidewall of the gate structure 614. The gate dielectric layer 630 is formed of an oxide-containing dielectric material, a silicon-containing dielectric material, a high-k dielectric material, or the like. In an embodiment, a dielectric constant of the gate dielectric layer 630 is greater than a dielectric constant of the ILD 623. The gate conductive layer 632 is formed of a silicon-containing layer, a polysilicon layer, a metal-containing layer, a titanium-containing material or combinations thereof. The spacer 634 is formed adjacent a sidewall of the gate dielectric layer 630, a sidewall of the gate conductive layer 632, or a combination thereof. The spacer 634 is a single-layer structure or a multi-layered structure formed of an oxide-containing dielectric material, an nitride-containing dielectric material, an oxynitride-containing dielectric material, or combinations thereof. In an embodiment, a dielectric constant of the gate dielectric layer 630 is greater than a dielectric constant of the spacer 634. In an embodiment, a dielectric constant of the gate dielectric layer 630 is greater than a dielectric constant of the ILD 623.

Source/drain region(s) 616 may refer to a source or a drain, individually or collectively dependent upon the context. The source/drain region 616 is a silicon-containing region aside the gate structure 614. In an embodiment, the source/drain region 616 includes at least an epitaxial structure with a dopant. The conductive plugs 612 may be formed of tungsten, cobalt, nickel, copper, silver, gold, aluminum, the like, or combinations thereof.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process, the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the second bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6A additionally illustrates that, once the first semiconductor device 601 has been bonded, a gap-fill material 613 is deposited in order to fill the space around the first semiconductor device 601 and provide additional support. In an embodiment the gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the second gap-fill material 613 has been deposited, the gap-fill material 613 may be planarized in order to expose the first semiconductor device 601. In an embodiment the planarization process may be a chemical mechanical planarization process, a grinding process, or the like. However, any suitable planarization process may be utilized.

FIG. 7A illustrates an attachment of a support substrate 701 to the first semiconductor device 601 and the gap-fill material 613. In an embodiment the support substrate 701 may be a support material that is transparent to the wavelength of light that is desired to be used, such as silicon, and may be attached using, e.g., an adhesive (not separately illustrated in FIG. 7A). However, in other embodiments the support substrate 701 may be bonded to the first semiconductor device 601 and the gap-fill material 613 using, e.g., a bonding process. Any suitable method of attaching the support substrate 701 may be used.

FIG. 7A additionally illustrates that the support substrate 701 comprises coupling lenses 703 positioned to facilitate optical coupling between optical inputs (e.g., optical fibers that are not illustrated in FIG. 7A) and the optical interposer 100. The coupling lenses 703 may be arranged in the form of an array that comprises multiple rows of lenses, wherein the multiple rows of lenses are disposed to be vertically above and aligned with corresponding rows of the grating couplers 204 that were described previously in FIG. 2. Each coupling lens 703 within a row of the array may fully or partially overlap a corresponding grating coupler 204. In an embodiment, the coupling lenses 703 may be formed on a top surface of the support substrate 701 by shaping the material of the support substrate 701 (e.g., silicon) using masking and etching processes. However, any suitable process may be utilized. FIG. 7B illustrates a region 704 of the support substrate 701 that is shown in FIG. 7A. FIG. 7B further illustrates that each coupling lens 703 may have a convex shape that protrudes from a top surface of the support substrate 701. The coupling lens 703 may also include recessed portions 706 that are disposed at edge regions of the coupling lens 703. The depth and width of the recessed portions 706 can be controlled through the masking and etching processes to achieve the desired shape and dimensions of the coupling lens 703. The convex shape of the coupling lens 703 is designed to focus incoming light onto the corresponding grating coupler 204 (not shown in FIG. 7B) located beneath the coupling lens 703 on the optical interposer 100. The specific curvature and geometry of the coupling lens 703 can be optimized based on factors such as the wavelength of the light, the refractive index of the support substrate material, and the intended focal point.

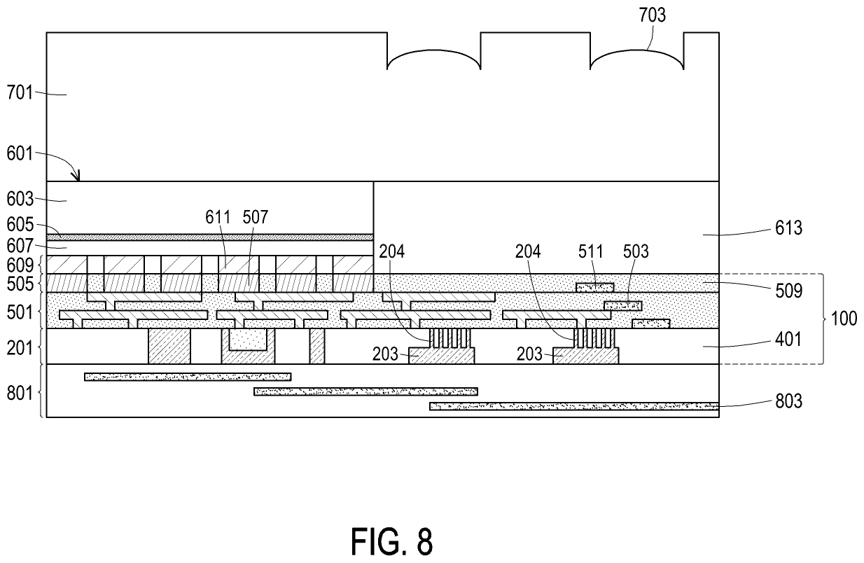

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

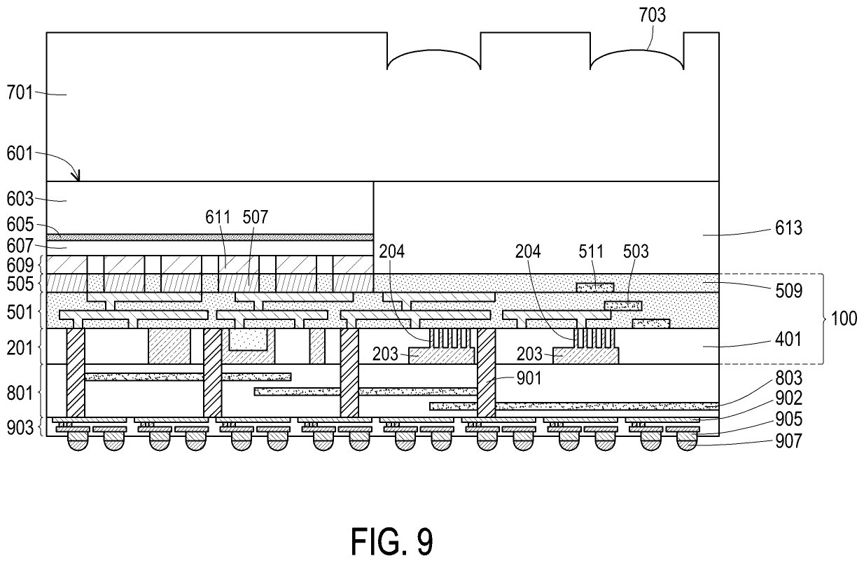

FIG. 9 illustrates the formation of first through device vias (TDVs) 901, and the formation of a redistribution structure 903. In an embodiment, the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

FIG. 9 further illustrates the formation of the redistribution structure 903 and conductive connectors 907 on the second active layer 801. To form the redistribution structure 903, conductive pads 902 are first formed on the second active layer 801, wherein the conductive pads 902 are physically and electrically connected to the first through device vias 901. In accordance with some embodiments, the conductive pads 902 may be formed by initially forming a seed layer (not shown) of one or more thin layers of a conductive material that aids in the formation of a thicker layer during subsequent processing steps. The seed layer may comprise a layer of titanium or copper formed using processes such as sputtering, evaporation, PECVD, or the like. A photoresist (also not shown) may then be formed and patterned to cover the seed layer using, e.g., a spin coating technique. Once the photoresist has been formed and patterned, a conductive material may be formed on the seed layer. The conductive material may be a material such as copper, titanium, tungsten, aluminum, another metal, the like, or a combination thereof. The conductive material may be formed through a deposition process such as electroplating, electroless plating, or the like. Once the conductive material has been formed, the photoresist may be removed through a suitable removal process such as ashing or chemical stripping. Additionally, after the removal of the photoresist, those portions of the seed layer that were covered by the photoresist may be removed through, for example, a suitable wet etch process or dry etch process, which may use the conductive material as an etch mask. The remaining portions of the seed layer and conductive material on the second active layer 801 form the conductive pads 902.

The remainder of the redistribution structure 903 is then formed on the second active layer 801 and the conductive pads 902. The redistribution structure 903 may include a metallization layer that comprises one or more dielectric layer(s) and respective metallization pattern(s) in the dielectric layer(s). The metallization patterns may comprise vias and/or traces to interconnect the first through device vias 901 together and/or to an external device. The dielectric layers may comprise silicon oxide, silicon nitride, silicon carbide, silicon oxynitride, low-K dielectric material, such as phosphosilicate glass (PSG), borophosphosilicate glass (BPSG), fluorinated silicate glass (FSG), SiOxCy, Spin-On-Glass, Spin-On-Polymers, silicon carbon material, compounds thereof, composites thereof, combinations thereof, or the like. The dielectric layers may be deposited by any suitable method known in the art, such as spinning, CVD, PECVD, HDP-CVD, or the like. A metallization pattern may be formed in the dielectric layer, for example, by using photolithography techniques to deposit and pattern a photoresist material on the dielectric layer to expose portions of the dielectric layer that are to become the metallization pattern. An etch process, such as an anisotropic dry etch process, may be used to create recesses and/or openings in the dielectric layer corresponding to the exposed portions of the dielectric layer. The recesses and/or openings may be lined with a diffusion barrier layer and filled with a conductive material. The diffusion barrier layer may comprise one or more layers of TaN, Ta, TiN, Ti, CoW, or the like, deposited by ALD, or the like, and the conductive material may comprise copper, aluminum, tungsten, silver, and combinations thereof, or the like, deposited by CVD, PVD, or the like. Any excessive diffusion barrier layer and/or conductive material on the dielectric layer may be removed, such as by using a CMP.

Referring further to FIG. 9, conductive pads 905 are formed at a bottom surface of the redistribution structure 903. The conductive pads 905 are formed in openings of the dielectric layers of the redistribution structure 903. The openings are formed using acceptable photolithography and etching processes, and the openings may expose a bottommost metallization pattern of the redistribution structure 903. In some embodiments, the conductive pads 905 include under bump metallurgies (UBMs). As an example to form the conductive pads 905, a seed layer (not shown) is formed at least in the openings in the dielectric layer of the redistribution structure 903. In some embodiments, the seed layer is a metal layer, which may be a single layer or a composite layer comprising a plurality of sub-layers formed of different materials. In some embodiments, the seed layer comprises a titanium layer and a copper layer over the titanium layer. The seed layer may be formed using, for example, PVD or the like. A photoresist is then formed and patterned on the seed layer. The photoresist may be formed by spin coating or the like and may be exposed to light for patterning. The pattern of the photoresist corresponds to the conductive pads 905. The patterning forms openings through the photoresist to expose the seed layer. A conductive material is formed in the openings of the photoresist and on the exposed portions of the seed layer. The conductive material may be formed by plating, such as electroplating or electroless plating, or the like. The conductive material may comprise a metal, like copper, titanium, tungsten, aluminum, or the like. Then, the photoresist and portions of the seed layer on which the conductive material is not formed are removed. The photoresist may be removed by an acceptable ashing or stripping process, such as using an oxygen plasma or the like. Once the photoresist is removed, exposed portions of the seed layer are removed, such as by using an acceptable etching process, such as by wet or dry etching. The remaining portions of the seed layer and conductive material form the conductive pads 905.

Conductive connectors 907 are then formed on the conductive pads 905. The conductive connectors 907 are electrically coupled to the redistribution structure 903 and the first through device vias 901 through the conductive pads 905. The conductive connectors 907 may comprise controlled collapse chip connection (C4) bumps, micro bumps, solder balls, or the like. The conductive connectors 907 may comprise a conductive material such as solder, copper, aluminum, gold, nickel, silver, palladium, tin, the like, or a combination thereof. In some embodiments, the conductive connector 907 includes an intermetallic compound (IMC) region. The IMC region includes tin, copper, nickel, silver, palladium, the like or a combination thereof. In some embodiments, the conductive connectors 907 are formed by initially forming a layer of solder through evaporation, electroplating, printing, solder transfer, ball placement, or the like. Once a layer of solder has been formed on the structure, a reflow may be performed in order to shape the material into the desired bump shapes. In another embodiment, the conductive connectors 907 comprise metal pillars (such as a copper pillar) formed by a sputtering, printing, electro plating, electroless plating, CVD, or the like. The metal pillars may be solder free and have substantially vertical sidewalls. In some embodiments, a metal cap layer is formed on the top of the metal pillars. The metal cap layer may comprise nickel, tin, tin-lead, gold, silver, palladium, indium, nickel-palladium-gold, nickel-gold, the like, or a combination thereof and may be formed by a plating process.

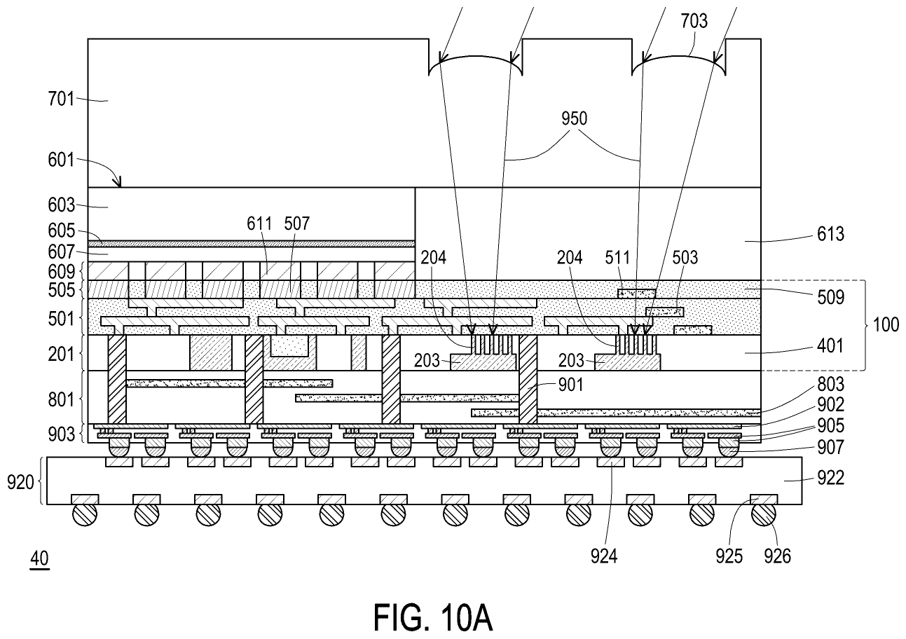

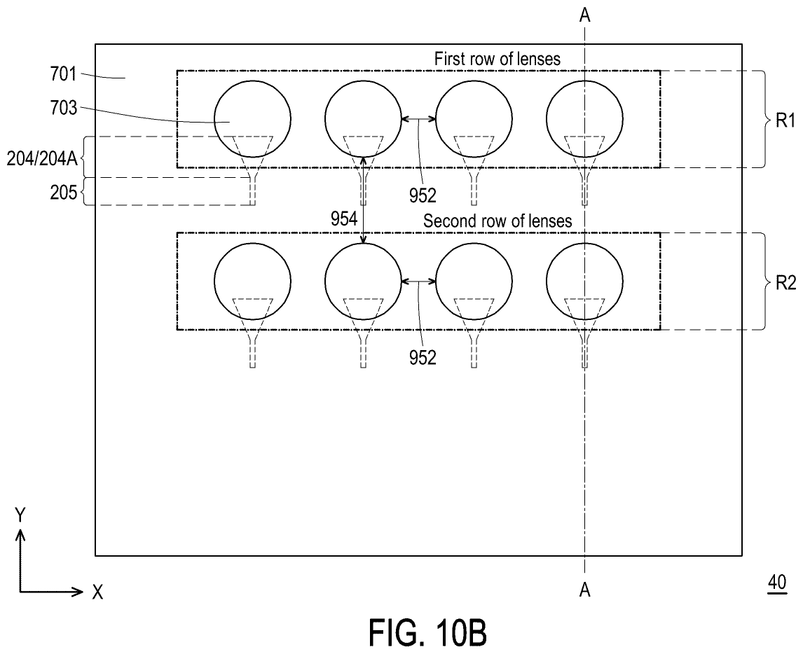

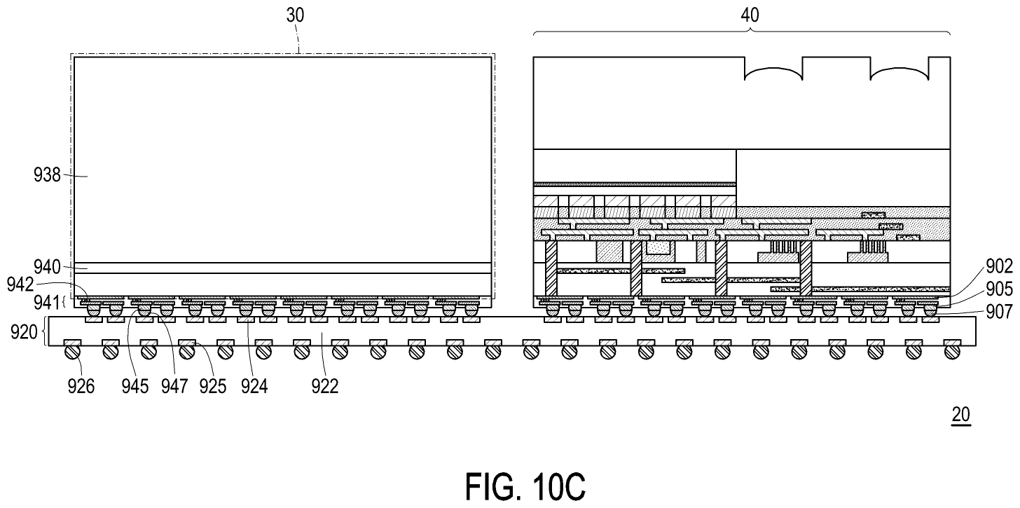

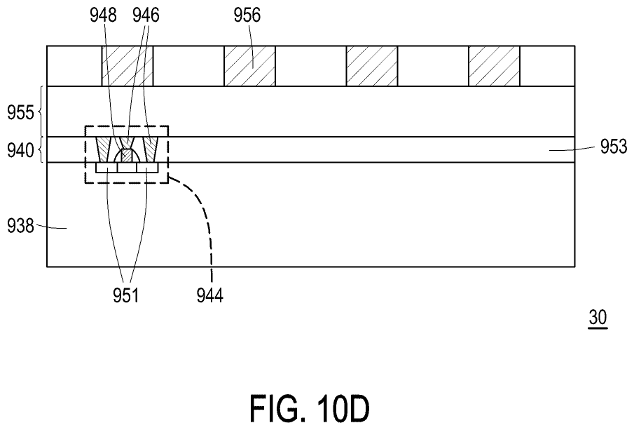

In FIGS. 10A and 10B, the first optical package 40 may then be mounted on a structure 920 using the conductive connectors 907. FIG. 10A is a cross-sectional view of the first optical package 40 along a line A-A that is shown in FIG. 10B. FIG. 10B is a top-down view of the first optical package 40. The structure 920 may comprise a package substrate that includes a substrate core 922, bond pads 924 over the substrate core 922, and bond pads 925 below the substrate core 922. The substrate core 922 may be made of a semiconductor material such as silicon, germanium, diamond, or the like. Alternatively, compound materials such as silicon germanium, silicon carbide, gallium arsenic, indium arsenide, indium phosphide, silicon germanium carbide, gallium arsenic phosphide, gallium indium phosphide, combinations of these, and the like, may also be used. Additionally, the substrate core 922 may be a SOI substrate. Generally, an SOI substrate includes a layer of a semiconductor material such as epitaxial silicon, germanium, silicon germanium, SOI, SGOI, or combinations thereof. The substrate core 922 is, in one alternative embodiment, based on an insulating core such as a fiberglass reinforced resin core. One example core material is fiberglass resin such as FR4. Alternatives for the core material include bismaleimide-triazine BT resin, or alternatively, other PCB materials or films. Build up films such as ABF or other laminates may be used for substrate core 922.

The substrate core 922 may include active and passive devices (not shown). A wide variety of devices such as transistors, capacitors, resistors, combinations of these, and the like may be used to generate the structural and functional requirements of the design for the device stack. The devices may be formed using any suitable methods.

The substrate core 922 may also include metallization layers and vias (not shown), with the bond pads 924 and the bond pads 925 being physically and/or electrically coupled to the metallization layers and vias. The metallization layers may be formed over the active and passive devices and are designed to connect the various devices to form functional circuitry. The metallization layers may be formed of alternating layers of dielectric (e.g., low-k dielectric material) and conductive material (e.g., copper) with vias interconnecting the layers of conductive material and may be formed through any suitable process (such as deposition, damascene, dual damascene, or the like). In some embodiments, the substrate core 922 is substantially free of active and passive devices.

In an embodiment, conductive connectors 926 may be formed on the bond pads 925. The conductive connectors 926 are electrically coupled to the structure 920. The conductive connectors 926 may comprise controlled collapse chip connection (C4) bumps, micro bumps, solder balls, or the like. The conductive connectors 926 may comprise a conductive material such as solder, copper, aluminum, gold, nickel, silver, palladium, tin, the like, or a combination thereof. In some embodiments, the conductive connectors 926 are formed by initially forming a layer of solder through evaporation, electroplating, printing, solder transfer, ball placement, or the like. Once a layer of solder has been formed on the structure, a reflow may be performed in order to shape the material into the desired bump shapes. In some embodiments, the conductive connector 926 includes an intermetallic compound (IMC) region. The IMC region includes tin, copper, nickel, silver, palladium, the like or a combination thereof.

In some embodiments, the conductive connectors 907 are reflowed to attach the conductive connectors 907 to the bond pads 924. The conductive connectors 907 electrically and/or physically couple the structure 920, including metallization layers in the substrate core 922, to the first optical package 40. In some embodiments, a solder resist is formed on the substrate core 922. The conductive connectors 907 may be disposed in openings in the solder resist to be electrically and mechanically coupled to the bond pads 924. The solder resist may be used to protect areas of the substrate core 922 from external damage.

In accordance with an alternate embodiment, the structure 920 may comprise an interposer, and a redistribution structure on the interposer. The first optical package 40 may be bonded to topmost redistribution lines of the redistribution structure using the conductive connectors 907. In this way, the first optical package 40 may be electrically connected to conductive vias of the interposer through the conductive connectors 907 and the redistribution structure.

FIG. 10B illustrates that the coupling lenses 703 of the support substrate 701 of the first optical package 40 may be arranged in the form of an array that comprises multiple rows of lenses, wherein the multiple rows of lenses are disposed to be above and aligned with corresponding rows of the grating couplers 204 that were described previously in FIG. 2. Each coupling lens 703 within a row of the array may fully or partially overlap a corresponding grating coupler 204. For example, FIG. 10B shows that the first optical package 40 is arranged in the form of an array that comprises multiple rows of lenses (e.g., a row R1, a row R2, or the like) wherein each row of the multiple rows of lenses is disposed to be above and aligned with a corresponding row of the grating couplers 204. In this way, each coupling lens 703 may fully or partially overlap a corresponding grating coupler 204 that is disposed below it. Even though FIG. 10B illustrates the first optical package 40 comprising an array that has two rows (e.g., the row R1 and the row R2), the first optical package 40 may comprise an array that has more than two rows.

In an embodiment, and as shown in FIG. 10B, the coupling lenses 703 of the array, and their corresponding grating couplers 204 may be distributed in a regular, grid-like pattern where a spacing 952 in a first direction (e.g., the x-direction) between adjacent coupling lenses 703 within each row (e.g., the row R1, the row R2, or the like) is uniform, creating an even distribution along the row. In addition, the rows of the array may each have a same number of coupling lenses 703. Furthermore, in a second direction (e.g., the y-direction), each coupling lens 703 in a row (e.g., the row R1) is aligned with and adjacent to a corresponding coupling lens 703 of an adjacent row (e.g., the row R2), wherein the second direction is orthogonal to the first direction (e.g., the x-direction). A spacing 954 in the second direction (e.g., the y-direction) between each coupling lens 703 of a row (e.g., the row R1) and an adjacent coupling lens 703 of an adjacent row (e.g., the row R2) is uniform.

In an embodiment, each grating coupler 204 of each row of the grating couplers 204 may be a one-dimensional (1D) grating coupler 204A that is designed to couple light in one direction along a corresponding waveguide 205, wherein the 1D grating coupler 204A may be formed to be in physical contact with or near a surface of the corresponding waveguide 205. In other embodiments, the grating couplers 204 may comprise one or more 1D grating couplers 204A and one or more two-dimensional (2D) grating couplers. Each 2D grating coupler may be designed to couple light in more than one direction along corresponding waveguides, wherein the 2D grating coupler may be formed to be in physical contact with or near surfaces of the corresponding waveguides.

FIGS. 10A and 10B also illustrate arrows which represent a number of optical paths for optical signals 950 that are received by the first optical package 40. These arrows represent a general direction of travel for the optical signals 950 within the various layers of the first optical package 40, and do not necessarily represent the exact path that the optical signals 950 travel through. Each coupling lens 703 of the array may receive one or more corresponding optical signals 950 (e.g., in the form of light) from an external source (not shown) and direct them towards a corresponding grating coupler 204 (e.g., a 1D grating coupler 204A) that is disposed below the coupling lens 703. The corresponding grating coupler 204 may then couple the optical signals received in one direction along a corresponding waveguide 205.

Advantageous features may be achieved by forming the first optical package 40 that comprises the coupling lenses 703 that are arranged in the form of an array that comprises multiple rows (e.g., a row R1, a row R2, or the like) of the coupling lenses 703, wherein each row of the multiple rows of the coupling lenses 703 is disposed to be above and aligned with a corresponding row of the grating couplers 204 (e.g., 1D grating couplers 204A). In this way, each coupling lens 703 may fully or partially overlap a corresponding grating coupler 204 that is disposed below it. The coupling lenses 703 of the array, and their corresponding grating couplers 204 may be distributed in a regular, grid-like pattern where the spacing 952 in the first direction (e.g., the x-direction) between adjacent coupling lenses 703 within each row (e.g., the row R1, the row R2, or the like) is uniform, creating an even distribution along the row. In addition, the rows of the array may each have a same number of coupling lenses 703. Furthermore, in the second direction (e.g., the y-direction), each coupling lens 703 in a row (e.g., the row R1) is aligned with and adjacent to a corresponding coupling lens 703 of an adjacent row (e.g., the row R2), wherein the second direction is orthogonal to the first direction (e.g., the x-direction). The spacing 954 in the second direction (e.g., the y-direction) between each coupling lens 703 of a row (e.g., the row R1) and an adjacent coupling lens 703 of an adjacent row (e.g., the row R2) is uniform. These advantages include the array of coupling lenses 703 that are arranged in multiple rows allowing for an increase in the optical input/output (I/O) capacity of the first optical package 40. This increased I/O density allows for a greater number of optical channels to operate simultaneously within the same footprint of the first optical package 40, thereby expanding the optical communication bandwidth and increasing the data transmission capabilities of the first optical package 40. In addition, the embodiments provide methods that have a high compatibility with existing manufacturing processes, and that can be easily integrated with the existing manufacturing processes. This may result in reduced manufacturing costs.

FIG. 10C illustrates the formation of a package component 20, in accordance with some other embodiments. Unless specified otherwise, like reference numerals in this embodiment (and subsequently discussed embodiments) represent like components in the embodiment shown in FIGS. 1 through 10B formed by like processes. Accordingly, the process steps and applicable materials may not be repeated herein.

In FIG. 10C, the first optical package 40 may be mounted on the structure 920 using the conductive connectors 907 using the materials and processes described previously in the FIGS. 10A and 10B. In addition, a package component 30 may also be mounted on the structure 920, such that the package component 30 and the first optical package 40 are adjacent to each other. The package component 30 is further illustrated in FIG. 10D. In some embodiments, the package component 30 comprises an application-specific integrated circuit (ASIC), processing die, a central processing unit (CPU), a graphics processing unit (GPU), a logic die, a high performance computing (HPC) die, the like, or a combination thereof. The package component 30 may comprise active devices 940 such as transistors 944, and an inter-layer dielectric (ILD) 953 over the front surface of a semiconductor substrate 938. The ILD 953 surrounds and may cover the transistors 944. The ILD 953 may include one or more dielectric layers formed of materials such as Phospho-Silicate Glass (PSG), Boro-Silicate Glass (BSG), Boron-Doped Phospho-Silicate Glass (BPSG), undoped Silicate Glass (USG), or the like.

Conductive plugs 946 extend through the ILD 953 to electrically and physically couple the transistors 944. For example, the conductive plugs 946 may couple gates 948 and source/drain regions 951 of the transistors 944. Source/drain region(s) 951 may refer to a source or a drain, individually or collectively dependent upon the context. The conductive plugs 946 may be formed of tungsten, cobalt, nickel, copper, silver, gold, aluminum, the like, or combinations thereof. An interconnect structure 955 may be disposed over the active devices 940 and the ILD 953. Die connectors 956, such as conductive pillars (for example, formed of a metal such as copper) may be disposed over the interconnect structure 955 in order to couple to the respective integrated circuits of the package component 30.

Referring further to FIG. 10C, a redistribution structure 941 is formed over package component 30. The redistribution structure 941 may comprise conductive pads 942 and conductive pads 945. The redistribution structure 941, the conductive pads 942, and the conductive pads 945 may be formed using similar materials and methods as were described previously in FIG. 9 for the formation of the redistribution structure 903, the conductive pads 902, and the conductive pads 905, respectively. After the formation of the redistribution structure 941, conductive connectors 947 are then formed on the conductive pads 945 using similar processes and materials as were described previously in FIG. 9 for the formation the conductive connectors 907.

In some embodiments, the conductive connectors 947 are reflowed to attach the conductive connectors 947 to the bond pads 924. The conductive connectors 947 electrically and/or physically couple the structure 920, including metallization layers in the substrate core 922, to the package component 30. In some embodiments, a solder resist is formed on the substrate core 922. The conductive connectors 947 may be disposed in openings in the solder resist to be electrically and mechanically coupled to the bond pads 924. The solder resist may be used to protect areas of the substrate core 922 from external damage. The package component 30 may process and generate electrical signals that are transmitted through the redistribution structure 941, conductive connectors 947, and the metallization layers in the substrate core 922 on to the first optical package 40.

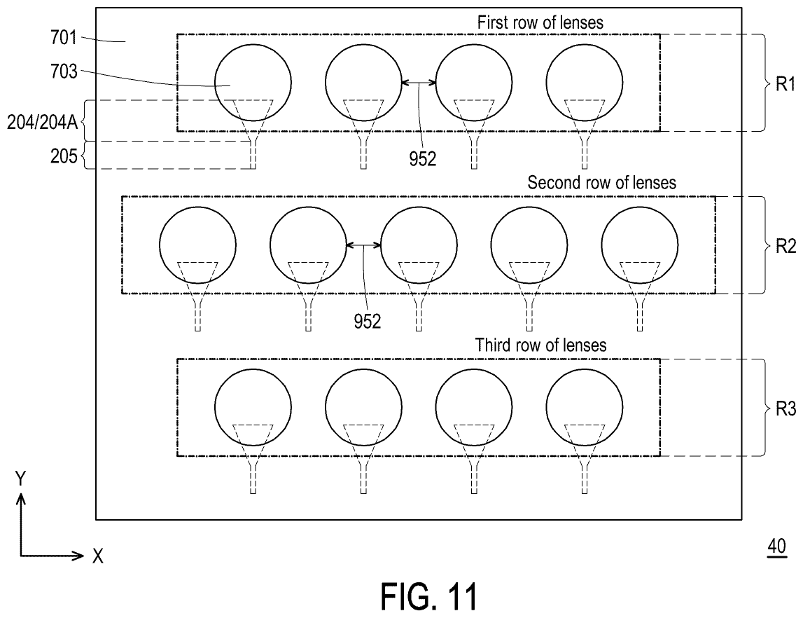

FIG. 11 illustrates a top-down view of the first optical package 40 in accordance with some other embodiments. Unless specified otherwise, like reference numerals in this embodiment (and subsequently discussed embodiments) represent like components in the embodiment shown in FIGS. 1 through 10B formed by like processes. Accordingly, the process steps and applicable materials may not be repeated herein.

FIG. 11 shows that the first optical package 40 may arranged in the form of an array that comprises multiple rows of lenses (e.g., a row R1, a row R2, a row R3, or the like) wherein each row of the multiple rows of lenses is disposed to be above and aligned with a corresponding row of the grating couplers 204 (e.g., 1D grating couplers 204A). In this way, each coupling lens 703 may fully or partially overlap a corresponding 1D grating coupler 204A that is disposed below it. Each 1D grating coupler 204A may be designed to couple light in one direction along a corresponding waveguide 205, wherein the 1D grating coupler 204A may be formed to be in physical contact with or near a surface of the corresponding waveguide 205. Even though FIG. 11 illustrates the first optical package 40 comprising an array that has three rows (e.g., the row R1, the row R2, and the row R3), the first optical package 40 may comprise an array that has more than two rows.

The coupling lenses 703 and their corresponding grating couplers 204 are distributed in a regular, grid-like pattern. The spacing 952 in the first direction (e.g., the x-direction) between adjacent coupling lenses 703 within each row is uniform. However, the array in FIG. 11 shows a delta arrangement of the rows (e.g., the row R1, the row R2, and the row R3), wherein the rows of the array are arranged to have an alternating number of coupling lenses 703. For example, the row R1 comprises four coupling lenses 703, the row R2 comprises five coupling lenses 703, and the row R3 comprises four coupling lenses 703. This configuration creates a staggered or offset pattern between adjacent rows (e.g., between the row R1 and the row R2, and between the row R2 and the row R3) in the second direction (e.g., the y-direction).

Advantageous features may be achieved by forming the first optical package 40 that comprises the coupling lenses 703 that are arranged in the form of an array that comprises multiple rows (e.g., a row R1, a row R2, a row R3, or the like) of the coupling lenses 703, wherein each row of the multiple rows of the coupling lenses 703 is disposed to be above and aligned with a corresponding row of the grating couplers 204 (e.g., 1D grating couplers 204A). In this way, each coupling lens 703 may fully or partially overlap a corresponding 1D grating coupler 204A that is disposed below it. The coupling lenses 703 and their corresponding grating couplers 204 are distributed in a regular, grid-like pattern. The spacing 952 in the first direction (e.g., the x-direction) between adjacent coupling lenses 703 within each row is uniform. The array of the coupling lenses 703 is disposed in a delta arrangement of the rows (e.g., the row R1, the row R2, and the row R3), wherein the rows of the array are arranged to have an alternating number of coupling lenses 703. This configuration creates a staggered or offset pattern between adjacent rows (e.g., between the row R1 and the row R2, and between the row R2 and the row R3) in the second direction (e.g., the y-direction). These advantages include allowing for an increased density (and an increased number) of the coupling lenses 703 to be formed on a given area of the support substrate 701 of the first optical package 40. In addition, the staggered or offset positioning between adjacent rows (e.g., between the row R1 and the row R2, and between the row R2 and the row R3) in the second direction (e.g., the y-direction) can allow for a more uniform coverage or distribution of the coupling lenses 703 across a top surface of the support substrate 701.

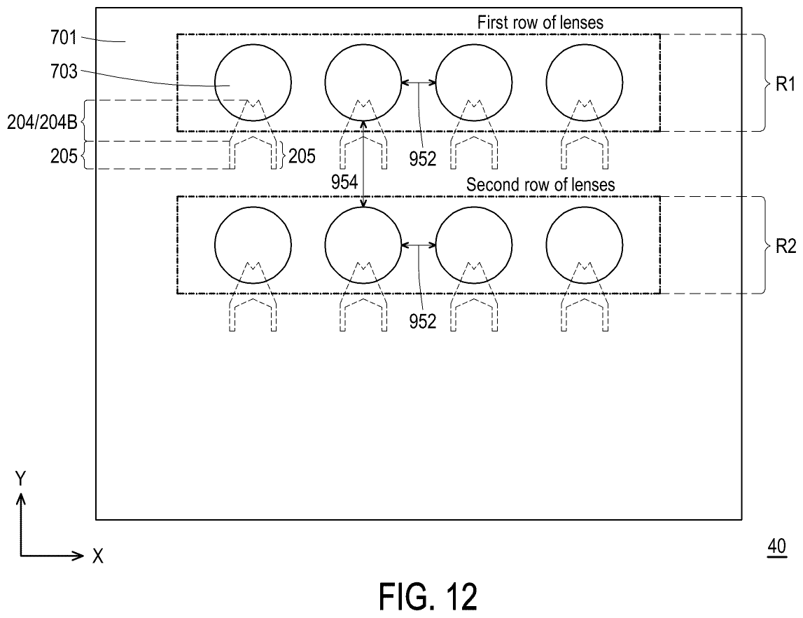

FIG. 12 illustrates a top-down view of the first optical package 40 in accordance with some other embodiments. Unless specified otherwise, like reference numerals in this embodiment (and subsequently discussed embodiments) represent like components in the embodiment shown in FIGS. 1 through 11 formed by like processes. Accordingly, the process steps and applicable materials may not be repeated herein.

FIG. 12 shows that the first optical package 40 may arranged in the form of an array that comprises multiple rows of lenses (e.g., a row R1, a row R2, or the like) wherein each row of the multiple rows of lenses is disposed to be above and aligned with a corresponding row of the grating couplers 204. In this way, each coupling lens 703 may fully or partially overlap a corresponding grating coupler 204 that is disposed below it. In an embodiment, each grating coupler 204 of each row of the grating couplers 204 may be a two-dimensional (2D) grating coupler 204B that is designed to couple light in more than one direction along corresponding waveguides 205, wherein the 2D grating coupler 204B may be formed to be in physical contact with or near surfaces of the corresponding waveguides 205. In other embodiments, the grating couplers 204 may comprise one or more 1D grating couplers 204A and one or more 2D grating couplers 204B. Even though FIG. 12 illustrates the first optical package 40 comprising an array that has two rows (e.g., the row R1, and the row R2), the first optical package 40 may comprise an array that has more than two rows.

In an embodiment, and as shown in FIG. 12, the coupling lenses 703 of the array, and their corresponding grating couplers 204 may be distributed in a regular, grid-like pattern where the spacing 952 in the first direction (e.g., the x-direction) between adjacent coupling lenses 703 within each row (e.g., the row R1, the row R2, or the like) is uniform, creating an even distribution along the row. In addition, the rows of the array may each have a same number of coupling lenses 703. Furthermore, in the second direction (e.g., the y-direction), each coupling lens 703 in a row (e.g., the row R1) is aligned with and adjacent to a corresponding coupling lens 703 of an adjacent row (e.g., the row R2), wherein the second direction is orthogonal to the first direction (e.g., the x-direction). The spacing 954 in the second direction (e.g., the y-direction) between each coupling lens 703 of a row (e.g., the row R1) and an adjacent coupling lens 703 of an adjacent row (e.g., the row R2) is uniform.

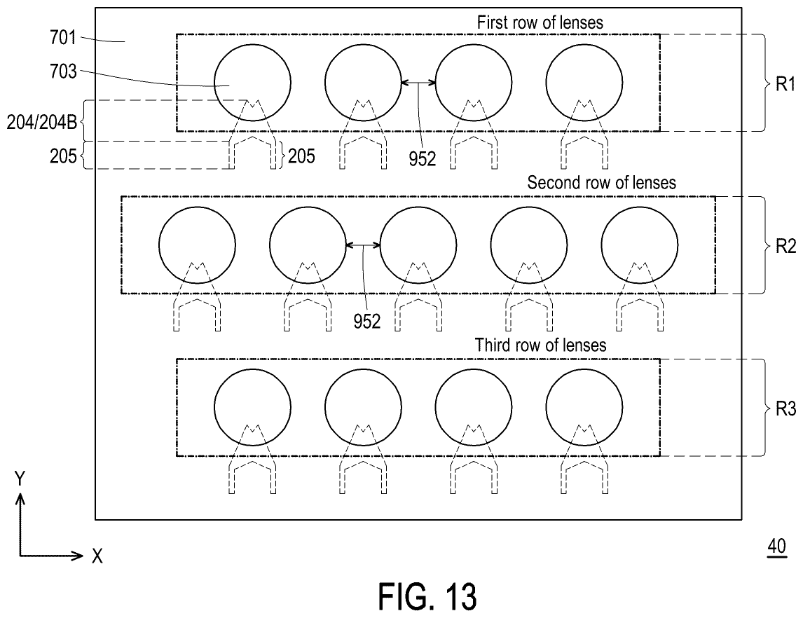

FIG. 13 illustrates a top-down view of the first optical package 40 in accordance with some other embodiments. Unless specified otherwise, like reference numerals in this embodiment (and subsequently discussed embodiments) represent like components in the embodiment shown in FIGS. 1 through 12 formed by like processes. Accordingly, the process steps and applicable materials may not be repeated herein.

FIG. 13 shows that the first optical package 40 may arranged in the form of an array that comprises multiple rows of lenses (e.g., a row R1, a row R2, a row R3, or the like) wherein each row of the multiple rows of lenses is disposed to be above and aligned with a corresponding row of the grating couplers 204 (e.g., 2D grating couplers 204B). In this way, each coupling lens 703 may fully or partially overlap a corresponding 2D grating coupler 204B that is disposed below it. Each 2D grating coupler 204B is designed to couple light in more than one direction along corresponding waveguides 205, wherein the 2D grating coupler 204B may be formed to be in physical contact with or near surfaces of the corresponding waveguides 205. Even though FIG. 13 illustrates the first optical package 40 comprising an array that has three rows (e.g., the row R1, the row R2, and the row R3), the first optical package 40 may comprise an array that has more than two rows.

The coupling lenses 703 and their corresponding grating couplers 204 are distributed in a regular, grid-like pattern. The spacing 952 in the first direction (e.g., the x-direction) between adjacent coupling lenses 703 within each row is uniform. However, the array in FIG. 13 shows a delta arrangement of the rows (e.g., the row R1, the row R2, and the row R3), wherein the rows of the array are arranged to have an alternating number of coupling lenses 703. For example, the row R1 comprises four coupling lenses 703, the row R2 comprises five coupling lenses 703, and the row R3 comprises four coupling lenses 703. This configuration creates a staggered or offset pattern between adjacent rows (e.g., between the row R1 and the row R2, and between the row R2 and the row R3) in the second direction (e.g., the y-direction).

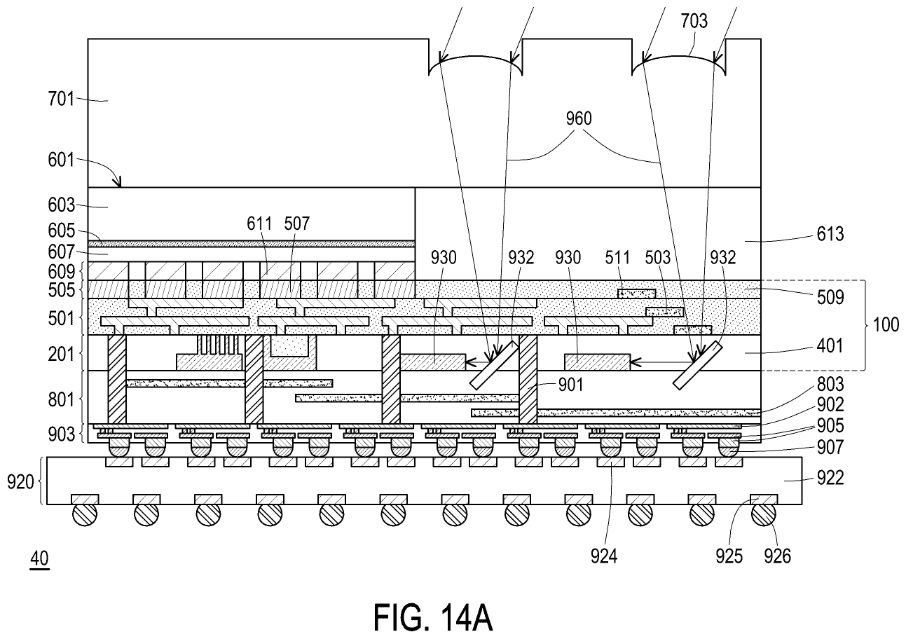

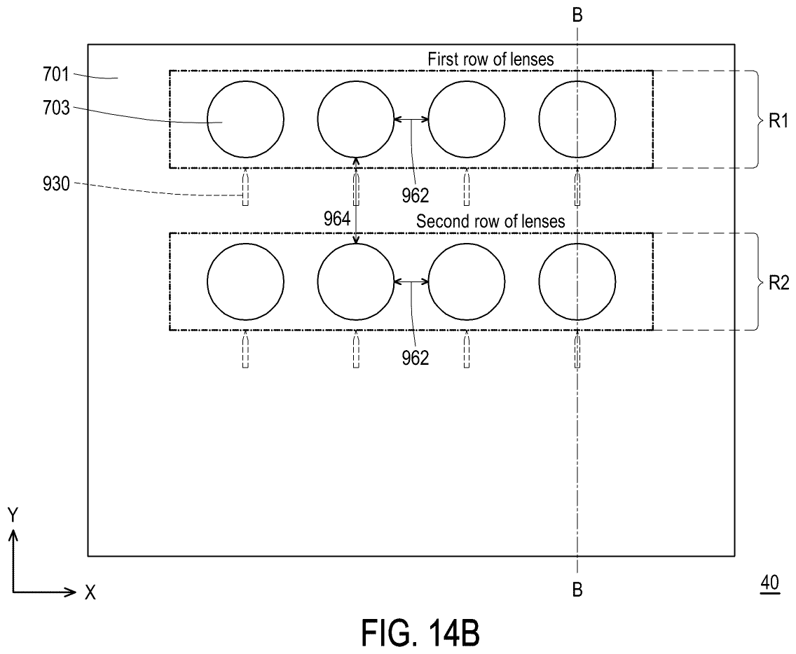

FIGS. 14A and 14B illustrate the first optical package 40 in accordance with some other embodiments. FIG. 14A is a cross-sectional view of the first optical package 40 along a line B-B that is shown in FIG. 14B. FIG. 14B is a top-down view of the first optical package 40. Unless specified otherwise, like reference numerals in this embodiment (and subsequently discussed embodiments) represent like components in the embodiment shown in FIGS. 1 through 13 formed by like processes. Accordingly, the process steps and applicable materials may not be repeated herein.

FIGS. 14A and 14B illustrate that the coupling lenses 703 of the support substrate 701 of the first optical package 40 may be arranged in the form of an array that comprises multiple rows of lenses, wherein the multiple rows of lenses are disposed to be above and aligned with corresponding rows of edge couplers 930. Each coupling lens 703 within a row of the array may be offset from a corresponding edge coupler 930 disposed below it, such that the coupling lens 703 does not overlap its corresponding edge coupler 930. In other embodiments, each coupling lens 703 within a row of the array may fully or partially overlap a corresponding edge coupler 930. For example, FIG. 14B shows that the first optical package 40 is arranged in the form of an array that comprises multiple rows of lenses (e.g., a row R1, a row R2, or the like) wherein each row of the multiple rows of lenses is disposed to be above and offset from a corresponding row of the edge couplers 930. In this way, each coupling lens 703 may be positioned above and offset from a corresponding edge coupler 930 that is disposed below it. Even though FIG. 14B illustrates the first optical package 40 comprising an array that has two rows (e.g., the row R1 and the row R2), the first optical package 40 may comprise an array that has more than two rows.

FIG. 14A additionally illustrates that mirrors 932 may be formed (e.g., in the form of an array of mirrors 932) within the first active layer 201 and/or the second active layer 801, wherein each mirror 932 is used to direct optical signals 960 that are received by a corresponding coupling lens 703 of the array towards a corresponding edge coupler 930 that is disposed below the coupling lens 703. In an embodiment, each mirror 932 may be disposed below its corresponding coupling lens 703, and may be disposed adjacent to its corresponding edge coupler 930. Each edge coupler 930 may be designed to facilitate an in-plane coupling of light (e.g., light that is directed to the edge coupler 930 by a corresponding mirror 932) in a direction along a corresponding waveguide. In an embodiment the mirrors 932 may be formed by initially forming recesses (not separately illustrated in FIG. 14A) using, e.g., a photolithographic masking and etching process. Once the recesses have been formed, a mirror coating may be deposited to line the recesses. In an embodiment the mirror coating may be a single layer of a reflective material such as aluminum copper, copper, gold, aluminum, combinations of these, or the like, or else may be a multi-layer structure such as a Bragg's reflector comprising alternating layers of silicon dioxide and amorphous silicon. The individual materials of the mirror coating may be deposited using any suitable methods, such as chemical vapor deposition, physical vapor deposition, plating, combinations of these, or the like, and the individual layers may be then be further patterned using, e.g., a photolithographic masking and etching process (for example, to remove horizontal portions of the deposited materials). In an embodiment, the material for the mirror coating may be deposited to a thickness of between about 500 Å and about 3000 Å. However, any suitable materials and methods may be utilized in order to form the mirror coating along the sidewalls of the recesses. The mirrors 932 may also be referred to subsequently as reflectors.

In an embodiment, and as shown in FIG. 14B, the coupling lenses 703 of the array, and their corresponding edge couplers 930 may be distributed in a regular, grid-like pattern where a spacing 962 in the first direction (e.g., the x-direction) between adjacent coupling lenses 703 within each row (e.g., the row R1, the row R2, or the like) is uniform, creating an even distribution along the row. In addition, the rows of the array may each have a same number of coupling lenses 703. Furthermore, in the second direction (e.g., the y-direction), each coupling lens 703 in a row (e.g., the row R1) is aligned with and adjacent to a corresponding coupling lens 703 of an adjacent row (e.g., the row R2), wherein the second direction is orthogonal to the first direction (e.g., the x-direction). A spacing 964 in the second direction (e.g., the y-direction) between each coupling lens 703 of a row (e.g., the row R1) and an adjacent coupling lens 703 of an adjacent row (e.g., the row R2) is uniform.

FIGS. 14A and 14B also illustrate arrows which represent a number of optical paths for the optical signals 960 that are received by the first optical package 40.

These arrows represent a general direction of travel for the optical signals 960 within the various layers of the first optical package 40, and do not necessarily represent the exact path that the optical signals 960 travel through. Each coupling lens 703 of the array may receive one or more corresponding optical signals 960 (e.g., in the form of light) from an external source (not shown) and direct them towards a corresponding mirror 932 that is disposed below the coupling lens 703. The corresponding mirror 932 may then direct the optical signals 960 towards a corresponding edge coupler 930 that is disposed below the coupling lens 703, the corresponding edge coupler 930 also being disposed adjacent to the mirror 932. The corresponding edge coupler 930 may facilitate an in-plane coupling of light (e.g., the optical signals 960) in a direction along a corresponding waveguide (not shown in the FIGS. 14A and 14B).

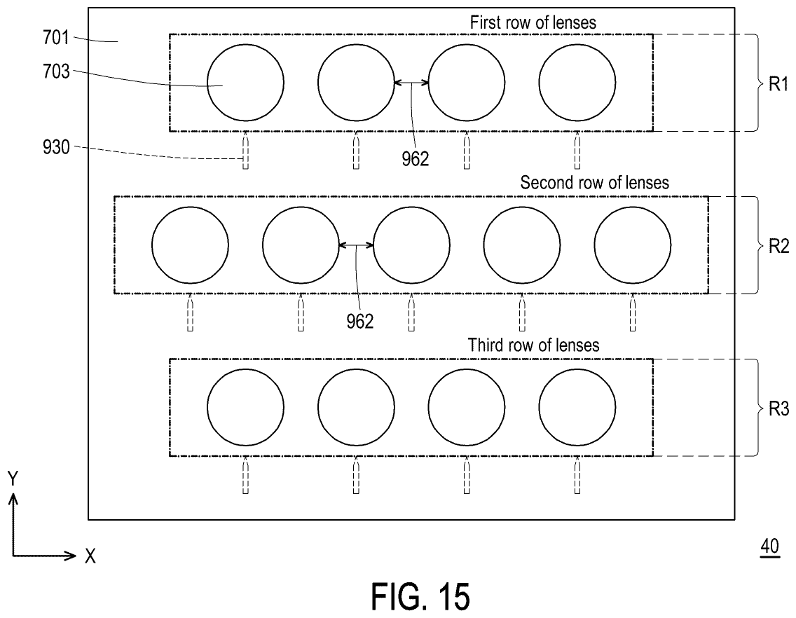

FIG. 15 illustrates a top-down view of the first optical package 40 in accordance with some other embodiments. Unless specified otherwise, like reference numerals in this embodiment (and subsequently discussed embodiments) represent like components in the embodiment shown in FIGS. 1 through 14B formed by like processes. Accordingly, the process steps and applicable materials may not be repeated herein.

FIG. 15 shows that the first optical package 40 may arranged in the form of an array that comprises multiple rows of lenses (e.g., a row R1, a row R2, a row R3, or the like) wherein each row of the multiple rows of lenses is disposed to be above and aligned with a corresponding row of edge couplers 930. Each coupling lens 703 within a row of the array may be offset from a corresponding edge coupler 930 that is disposed below it, such that the coupling lens 703 does not overlap its corresponding edge coupler 930. A corresponding mirror 932 (described previously in FIGS. 14A and 14B) may be used to direct the optical signals 960 (described previously in FIGS. 14A and 14B) received by the coupling lens 703 towards the corresponding edge coupler 930, the corresponding edge coupler 930 also being disposed adjacent to the corresponding mirror 932. The corresponding edge coupler 930 may facilitate an in-plane coupling of light (e.g., the optical signals 960) in a direction along a corresponding waveguide (not shown in the FIG. 15). Even though FIG. 15 illustrates the first optical package 40 comprising an array that has three rows (e.g., the row R1, the row R2, and the row R3), the first optical package 40 may comprise an array that has more than two rows.

The coupling lenses 703 and their corresponding edge couplers 930 are distributed in a regular, grid-like pattern. The spacing 962 in the first direction (e.g., the x-direction) between adjacent coupling lenses 703 within each row is uniform. However, the array in FIG. 15 shows a delta arrangement of the rows (e.g., the row R1, the row R2, and the row R3), wherein the rows of the array are arranged to have an alternating number of coupling lenses 703. For example, the row R1 comprises four coupling lenses 703, the row R2 comprises five coupling lenses 703, and the row R3 comprises four coupling lenses 703. This configuration creates a staggered or offset pattern between adjacent rows (e.g., between the row R1 and the row R2, and between the row R2 and the row R3) in the second direction (e.g., the y-direction).

The embodiments of the present disclosure have some advantageous features. The embodiments provide methods applied to, but not limited to, the formation of an optical engine that includes an array of silicon (Si) lenses arranged in multiple rows, with corresponding rows of couplers (e.g., grating couplers or edge couplers) positioned beneath these lenses. Advantageous features of one or more embodiments disclosed herein may include the array of silicon (Si) lenses that are arranged in multiple rows allowing for an increase in the optical input/output (I/O) capacity of the optical engine. This increased I/O density allows for a greater number of optical channels to operate simultaneously within the same footprint, thereby expanding the optical communication bandwidth and increasing the data transmission capabilities of the optical engine. In addition, the embodiments provide methods that have a high compatibility with existing manufacturing processes, and that can be easily integrated with the existing manufacturing processes. This may result in reduced manufacturing costs.

In accordance with an embodiment, a semiconductor package includes a photonic package coupled to a first side of a package substrate, the photonic package including a semiconductor substrate; an array including multiple rows of coupling lenses on a top surface of the semiconductor substrate; and multiple rows of couplers disposed below the multiple rows of coupling lenses, where each coupler of the multiple rows of couplers is disposed below a corresponding coupling lens of the multiple rows of coupling lenses; first conductive connectors disposed between the photonic package and the first side of the package substrate, where the first conductive connectors are attached to first bond pads on the first side of the package substrate, and where at least one of the first conductive connectors includes a first intermetallic region; and second conductive connectors disposed on a second side of the package substrate that is opposite the first side, where the second conductive connectors are attached to second bond pads on the second side the package substrate. In an e embodiment, each coupling lens of the multiple rows of coupling lenses fully or partially overlaps a corresponding coupler of the multiple rows of couplers, where the corresponding coupler is a grating coupler. In an embodiment, the grating coupler is a one-dimensional (1D) grating coupler. In an embodiment, the grating coupler is a two-dimensional (2D) grating coupler. In an embodiment, each coupling lens of the multiple rows of coupling lenses is offset from a corresponding coupler of the multiple rows of couplers that is disposed below the coupling lens, where the corresponding coupler is an edge coupler. In an embodiment, the photonic package further includes reflectors, and where each reflector is configured to direct optical signals that are received by a corresponding coupling lens of the multiple rows of coupling lenses towards a corresponding coupler. In an embodiment, a first spacing in a first direction between adjacent coupling lenses within each row of the multiple rows of coupling lenses is uniform, and where a second spacing between each coupling lens of a row and an adjacent coupling lens of an adjacent row in a second direction is uniform, where the second direction is orthogonal to the first direction. In an embodiment, a first spacing in a first direction between adjacent coupling lenses within each row of the multiple rows of coupling lenses is uniform, and where a first row of the multiple rows of coupling lenses is offset from a second row of the multiple rows of coupling lenses, and where the first row is adjacent to the second row.

In accordance with an embodiment, a package includes a package component coupled to a first side of a package substrate, the package component including first optical components embedded in a dielectric layer; an electronic die over the first optical components, the electronic die including a semiconductor substrate; a transistor on the semiconductor substrate, where the transistor includes a gate dielectric layer, a gate conductive layer on the gate dielectric layer and a spacer adjacent a sidewall of the gate conductive layer, where a dielectric constant of the gate dielectric layer is different from a dielectric constant of the spacer; and an inter-layer dielectric over the transistor, where a dielectric constant of the inter-layer dielectric is different from the dielectric constant of the gate dielectric layer; a support substrate over the electronic die; and a first array including multiple rows of coupling lenses on a top surface of the support substrate, where the first optical components include a second array that includes multiple rows of couplers. In an embodiment, each coupling lens of the first array fully or partially overlaps a corresponding coupler of the second array, where the corresponding coupler is a grating coupler. In an embodiment, the grating coupler is a one-dimensional (1D) grating coupler. In an embodiment, the grating coupler is a two-dimensional (2D) grating coupler. In an embodiment, each coupling lens of the first array is offset from a corresponding coupler of the second array, where the corresponding coupler is an edge coupler. In an embodiment, the package component further includes a third array that includes multiple rows of reflectors, where each reflector of the third array is configured to direct optical signals that are received by a corresponding coupling lens of the first array towards a corresponding coupler of the second array. In an embodiment, each row of the multiple rows of coupling lenses has a same number of coupling lenses.

In accordance with an embodiment, a method of forming a semiconductor package includes forming a first optical package, where forming the first optical package includes forming an optical interposer, where the optical interposer includes first optical components that are embedded in a dielectric layer; bonding an electronic die to a top surface of the optical interposer; and attaching a semiconductor substrate to a top surface of the electronic die, where the semiconductor substrate includes a first array that includes multiple rows of coupling lenses. In an embodiment, the method further includes coupling the first optical package to a package substrate using conductive connectors. In an embodiment, the first optical components include a second array that includes multiple rows of couplers. In an embodiment, each coupling lens of the first array fully or partially overlaps a corresponding coupler of the second array, where the corresponding coupler is a grating coupler. In an embodiment, each row of the multiple rows of coupling lenses has a same number of coupling lenses.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor package comprising:
a photonic package coupled to a first side of a package substrate, the photonic package comprising:
a semiconductor substrate;
an array comprising multiple rows of coupling lenses on a top surface of the semiconductor substrate; and
multiple rows of couplers disposed below the multiple rows of coupling lenses, wherein each coupler of the multiple rows of couplers is disposed below a corresponding coupling lens of the multiple rows of coupling lenses;
first conductive connectors disposed between the photonic package and the first side of the package substrate, wherein the first conductive connectors are attached to first bond pads on the first side of the package substrate, and wherein at least one of the first conductive connectors comprises a first intermetallic region; and
second conductive connectors disposed on a second side of the package substrate that is opposite the first side, wherein the second conductive connectors are attached to second bond pads on the second side the package substrate.

2. The semiconductor package of claim 1, wherein each coupling lens of the multiple rows of coupling lenses fully or partially overlaps a corresponding coupler of the multiple rows of couplers, wherein the corresponding coupler is a grating coupler.

3. The semiconductor package of claim 2, wherein the grating coupler is a one-dimensional (1D) grating coupler.

4. The semiconductor package of claim 2, wherein the grating coupler is a two-dimensional (2D) grating coupler.

5. The semiconductor package of claim 1, wherein each coupling lens of the multiple rows of coupling lenses is offset from a corresponding coupler of the multiple rows of couplers that is disposed below the coupling lens, wherein the corresponding coupler is an edge coupler.

6. The semiconductor package of claim 5, wherein the photonic package further comprises reflectors, and wherein each reflector is configured to direct optical signals that are received by a corresponding coupling lens of the multiple rows of coupling lenses towards a corresponding coupler.

7. The semiconductor package of claim 1, wherein a first spacing in a first direction between adjacent coupling lenses within each row of the multiple rows of coupling lenses is uniform, and wherein a second spacing between each coupling lens of a row and an adjacent coupling lens of an adjacent row in a second direction is uniform, wherein the second direction is orthogonal to the first direction.

8. The semiconductor package of claim 1, wherein a first spacing in a first direction between adjacent coupling lenses within each row of the multiple rows of coupling lenses is uniform, and wherein a first row of the multiple rows of coupling lenses is offset from a second row of the multiple rows of coupling lenses, and wherein the first row is adjacent to the second row.

9. A package comprising:
a package component coupled to a first side of a package substrate, the package component comprising:
first optical components embedded in a dielectric layer;
an electronic die over the first optical components, the electronic die comprising:
a semiconductor substrate;
a transistor on the semiconductor substrate, wherein the transistor comprises a gate dielectric layer, a gate conductive layer on the gate dielectric layer and a spacer adjacent a sidewall of the gate conductive layer, wherein a dielectric constant of the gate dielectric layer is different from a dielectric constant of the spacer; and
an inter-layer dielectric over the transistor, wherein a dielectric constant of the inter-layer dielectric is different from the dielectric constant of the gate dielectric layer;
a support substrate over the electronic die; and
a first array comprising multiple rows of coupling lenses on a top surface of the support substrate, wherein the first optical components comprise a second array that includes multiple rows of couplers.

10. The package of claim 9, wherein each coupling lens of the first array fully or partially overlaps a corresponding coupler of the second array, wherein the corresponding coupler is a grating coupler.

11. The package of claim 10, wherein the grating coupler is a one-dimensional (1D) grating coupler.

12. The package of claim 10, wherein the grating coupler is a two-dimensional (2D) grating coupler.

13. The package of claim 9, wherein each coupling lens of the first array is offset from a corresponding coupler of the second array, wherein the corresponding coupler is an edge coupler.

14. The package of claim 13, wherein the package component further comprises a third array that includes multiple rows of reflectors, wherein each reflector of the third array is configured to direct optical signals that are received by a corresponding coupling lens of the first array towards a corresponding coupler of the second array.

15. The package of claim 9, wherein each row of the multiple rows of coupling lenses has a same number of coupling lenses.

16. A method of forming a semiconductor package, the method comprising:
forming a first optical package, wherein forming the first optical package comprises:
forming an optical interposer, wherein the optical interposer comprises first optical components that are embedded in a dielectric layer;
bonding an electronic die to a top surface of the optical interposer; and
attaching a semiconductor substrate to a top surface of the electronic die, wherein the semiconductor substrate comprises a first array that includes multiple rows of coupling lenses.

17. The method of claim 16, further comprising coupling the first optical package to a package substrate using conductive connectors.

18. The method of claim 16, wherein the first optical components comprise a second array that includes multiple rows of couplers.

19. The method of claim 18, wherein each coupling lens of the first array fully or partially overlaps a corresponding coupler of the second array, wherein the corresponding coupler is a grating coupler.

20. The method of claim 18, wherein each row of the multiple rows of coupling lenses has a same number of coupling lenses.
